(19) United States
(12) Patent Application Publication
(10) Pub. No.: US 2016/0339870 A1
(43) Pub. Date: Nov. 24, 2016

(54) EMERGENCY OVERRIDE SYSTEM AND METHOD

(71) Applicant: GORDON*HOWARD ASSOCIATES, INC., Littleton, CO (US)

(72) Inventors: Gerald A. MORGAN, Littleton, CO (US); Christopher M. Macheca, Centennial, CO (US); Stanley G. SCHWARZ, Indialantic, FL (US); Franco CHIRICO, Highlands Ranch, CO (US)

(73) Assignee: GORDON*HOWARD ASSOCIATES, INC., Littleton, CO (US)

(21) Appl. No.: 14/717,796

(22) Filed: May 20, 2015

(51) Int. Cl. B60R 25/04; G06Q 40/00

(52) U.S. Cl. CPC B60R 25/04; G06Q 40/12

(57) ABSTRACT

Emergency Override System. The system comprises an onboard device configured to disable operation of a vehicle. The onboard device includes circuitry configured to connect to one or more user-actuated vehicle components. The onboard device is configured to enable operation of a vehicle disabled by the onboard device by enabling the vehicle on detection of a preselected sequence of actions from one of the one or more user-actuated vehicle components.

### BACKGROUND

The present invention relates to the use of a payment enforcement system that disables, alerts, and locates a vehicle in response to a missed payment or other event, and in particular to systems and methods for enabling an emergency override of such payment enforcement systems.

Lenders have various mechanisms for enforcing payment of debt obligations, particularly those obligations that arise from the sale of goods or property on credit. For example, mortgagees can foreclose on real property if a mortgagor defaults. Vehicle finance companies can repossess a vehicle in the event the owner fails to make timely payment. In some cases, foreclosure payment schedule enforcement mechanisms are expensive and/or cumbersome to implement. Accordingly, lenders often refuse to extend credit when the likelihood of default exceeds some amount, because of the expense or impracticality of repossessing or otherwise enforcing payment obligations. In particular, potential buyers with poor credit history may be denied credit when attempting to purchase a vehicle or other item because of the relatively high likelihood of default. In addition, payments on less expensive items such as appliances, computers, and the like are often difficult to enforce because repossession is far too expensive in relation to the value of the item itself, and because the item loses much of its value once it is used.

A payment enforcement system may be used whereby a vehicle (or other purchased property) is equipped with a device capable of disabling the vehicle in the event of non-payment. Whenever the purchaser/owner makes a timely payment, he or she is given a password or other code to enter, or the password or other code is sent via a wireless link to the device, such that entry of the password or code enables the vehicle for some limited period of time (usually until the next payment due date, plus some grace period). Failure to enter the password or code causes the vehicle to be disabled, for example by interrupting the starter circuitry. In other payment enforcement systems embodiments, a command may directly be sent via a wireless communication link to an onboard device to disable and enable the vehicle. The owner may be given some warning of impending disablement, and may also be provided with a limited number of emergency starts whereby the vehicle can be used a few times, for a preselected period of time, say 24 hours, by entering a preselected emergency access code on a remote entry device. Without the remote entry device, the operator cannot start the vehicle in an emergency. Thus, if the remote entry device is lost, forgotten or fails, the user cannot operate a disabled vehicle in the event of an emergency, and thus, there is a need in the art for systems and methods to override the payment enforcement system to enable emergency operation of the vehicle without the need for a remote entry device.

### BRIEF DESCRIPTION OF THE DRAWINGS

FIG. 1 shows a block diagram of a system in accordance with at least some embodiments;

FIG. 1A shows a block diagram of a portion of the system of FIG. 1 in accordance with at least some embodiments;

FIG. 2 shows a block diagram of a portion of the system of FIG. 1 in further detail in accordance with at least some embodiments; and

FIG. 3 shows a flow chart of a method in accordance with at least some embodiments.

### NOTATION AND NOMENCLATURE

Certain terms are used throughout the following description and claims to refer to particular system components. As one skilled in the art will appreciate, different companies may refer to a component and/or method by different names. This document does not intend to distinguish between components and/or methods that differ in name but not in function.

“Exemplary,” as used herein, means “serving as an example, instance, or illustration.” An embodiment described herein as “exemplary” is not necessarily to be construed as preferred or advantageous over other embodiments.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment. In the following description, numerous specific details are set forth such as specific time intervals, etc. to provide a thorough understanding of the present invention. However, it will be apparent to those skilled in the art that the present invention may be practiced without such specific details. In other instances, well-known circuits have been shown in block diagram form in order not to obscure the present invention in unnecessary detail. Furthermore, in describing an embodiment of the invention, the terms “assert” and “negate” and various grammatical forms thereof, may be used to avoid confusion when dealing with the mixture of “active high” and “active low” logic signals. “Assert” is used to refer to the rendering of a logic signal or register bit into its active, or logically true, state. “Negate” is used to refer to the rendering of a logic signal or register bit into its inactive, or logically false, state. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

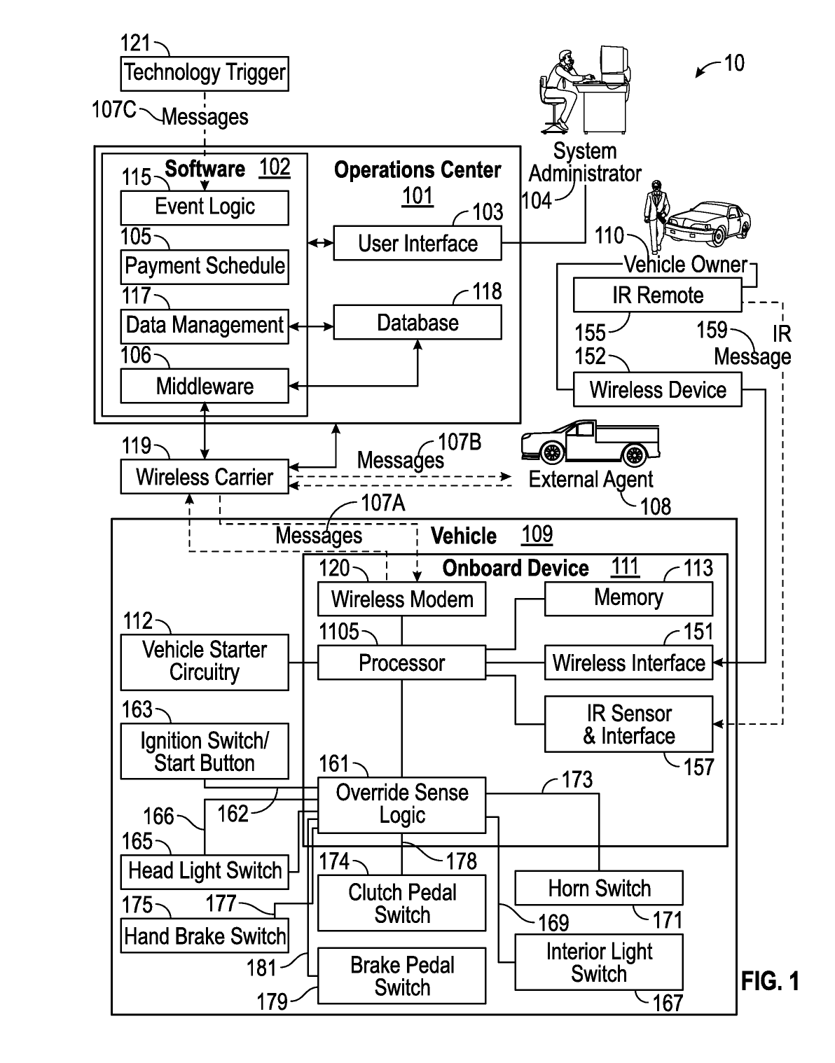

Refer now to FIG. 1 showing a block diagram of a system 10 which may comprise a payment enforcement system in accordance with at least some embodiments. Onboard device 111 is located in vehicle 109 and includes a processor 1105, which implements onboard functionality. Processor 1105 may be a PIC microcontroller such as the PIC16F876A CMOS FLASH-based 8-bit microcontroller, available from Microchip Technology Inc. of Chandler, Ariz., however, as would be appreciated by those skilled in the art having the benefit of the disclosure, any suitable processor may be used inasmuch as the principles of the exemplary embodiments are not dependent on the use of a particular processor.

Processor 1105 interfaces with wireless modem 120 for sending and receiving messages. Software running on processor 1105 controls enablement and disablement of vehicle starter circuitry 112. In at least some embodiments, processor 1105 is communicatively coupled to vehicle starter circuitry 112 to facilitate such disablement when needed. In other embodiments, processor 1105 is coupled to other vehicle circuitry such as a Controller Area Network (CAN) bus, onboard diagnostic (OBD) port, or the like, so that it can affect operation of vehicle 109 by disabling, curtailing, or limiting certain features and functions of vehicle 109 as appropriate. For example, under certain conditions, vehicle speed and/or vehicle functionality may be limited in response to a nonpayment event. Onboard device 111 also includes memory 113, such as RAM, to enable it to store preferences, configurations, schedules, and the like. For example, onboard device 111 may store a number of emergency overrides available to the owner or operator of vehicle 109 during a particular payment period, as described further below. In at least some embodiments memory 113 may comprise a discrete memory device coupled to processor 1105 and, in at least some other embodiments, may comprise memory devices integrated with processor 1105, and in still other embodiments may comprise a combination of both discrete memory devices and integrated memory devices.

Wireless interface 151 facilitates operation with a wireless device 152, which may be for example be a device communicating in accordance with the Bluetooth protocol, a Near Field Communication (NFC) protocol, wireless local area network (“Wi-Fi”) protocol or any other suitable protocol for short range wireless communication. In one embodiment, for example, Wireless interface 151 permits onboard device 111 to communicate with wireless device 152. Examples of such a wireless device 152 include a cellular telephone, personal digital assistant (PDA), laptop computer, handheld computer, tablet computer, smartphone or the like. Wireless device 152 can be a conventional cellular telephone that is capable of calling any number, or it can be a specialized cell phone that can only be used to communicate with the seller (or lender). Wireless device 152 may also be installed in vehicle 109 and be implemented as part of a navigation system such as a portable or in-car GPS-enabled navigation device with short range wireless communication functionality.

As described in further detail below, wireless device 152 can be also used as an input device for entry of passwords and the like. The owner can also enter a pass code on the wireless device's 152 keypad or touch-sensitive screen; wireless device 152 then communicates with onboard device 111 to enable use of vehicle 109 and/or to send messages 107A to operations center 101 indicating that a pass code has been entered. Validation of the pass code can take place at wireless device 152, or at onboard device 111, or at operations center 101. Wireless device 152 may also be used to enter an emergency override code, also described further below.

Further, wireless device 152 can send/receive messages directly to/from operations center 101 for example via SMS or other wireless protocols. Wireless device 152 can then relay appropriate messages to onboard device 111. In such an embodiment, device 152 acts as an intermediary for messages being sent from operations center 101 to onboard device 111.

Wireless device 152 can thus be used for programming and setting preferences on onboard device 111. For example, in at least some embodiments, a service mode is available for use by an administrator or other representative of operations center 101 or lender. A service password may be required before entering such a service mode. While in the service mode, the administrator can specify a number of emergency overrides available to a user during a payment period, and other settings using a user interface on wireless device 152 (not shown in FIG. 1). Wireless device 152 communicates with device 111 to cause such settings to be implemented on onboard device 111. Further, the user of wireless device 152 may also be informed of the number of available emergency overrides via the user interface on wireless device 152, such input/output (I/O) components 191 as shown in FIG. 1A.

FIG. 1A shows a block diagram of an exemplary wireless device 152. includes input/output components 191 including for example an output device such as a screen, an audio output device such as a speaker, and an input device such as a keypad, touch-sensitive screen, keyboard, buttons, rockers, rolling switches, and/or any combination thereof, in accordance with the art of cellular telephones, PDAs, tablet computers and the like. Wireless device 152 also includes a wireless interface 193 for facilitating communication with a Wi-Fi network, Bluetooth link, NFC link, a, host or cellular baseband processor 195 for facilitating wireless communication on a cellular network, and memory 197 such as RAM.

System administrator 104 may also interact with software 102 via user interface 103, which allows system administrator 104 to specify options, schedules, alert conditions, and the like, and also allows system administrator 104 to view reports, monitor system operations, and the like. System administrator 104 may be located at or near operations center 101, or may be remotely located, in which case interactions with software 102 may take place over a computer network such as the Internet, virtual private network, or the like, according to techniques that are well known to those of skill in the art.

Technology trigger 121 provides messages 107C specifying events that have occurred. Technology trigger 121 can be any source of information that is relevant to the payment schedule enforcement mechanism of the present invention. For example, technology trigger 121 may be a data stream providing information from a payment system, so that upon receipt of messages 107C from technology trigger 121, software causes payment schedule 105 and/or other information to be updated.

Event logic 115 specifies what actions should be taken in response to such messages 107C. For example, technology trigger 121 can inform software 102 that a payment has been received, or that a payment has been missed, or that some other event has taken place. Event logic 115 tells software 102 what to do in response to such events.

Payment schedule 105 for a particular debtor is stored, for example, in a database or other data store at operations center 101 or at some other location. Software 102 enforces payment schedule 105 by sending appropriate messages according to event logic 115, on-demand needs, or local override. Software 102 is communicatively coupled with accounting systems (not shown) or other sources of data that inform software 102 when a payment is late or when other relevant events take place that require messages 107A, 107B to be sent.

In at least some embodiments, software 102 also includes data management module 117, which maintains customer information, financial controls, verification data to ensure authenticity of messages 107A from vehicles 109, and the like. Such information can be stored in database 118, which in one embodiment is implemented as a SQL server database. Data management module 117 can also maintain payment schedules 105, and can specify changes to event logic 115, under the control of user interface 103.

In at least some embodiments, software 102 invokes middleware 106 to send messages 107A, via wireless carrier 119, to modem 120 associated with device 111 at vehicle 109. In one embodiment, middleware 106 can also be used for sending messages 107B to external agent 108, although in other embodiments messages 107B are sent directly by software 102. For example, middleware 106 can communicate with a cellular network via Internet Protocol; messages are then sent via the cellular network using a GSM or other protocol to modem 120 in vehicle 109. External agent 108 can receive information regarding vehicle 109 by other means, for example by receiving email messages from operations center 101, or by logging onto a web site run by operations center 101.

In one embodiment, messages are sent using an Access Point Name (APN) associated with a wireless carrier 119 communicating via a GPRS protocol. Any other network or protocol can be used, including for example GSM, CMDA, or the like. The APN enables sending and/or receiving messages to external agent 108 and/or wireless modem 120 on onboard device 111. Middleware 106 provides an interface by which software 102 can communicate with many different types of devices, systems, computers, vehicles, nodes, and the like, via a variety of protocols, to provide mobile device control and data acquisition functionality. Essentially, middleware 106 acts a protocol translation module between software 102 and whatever entities software 102 communicates with. For example, for certain devices 111, Internet Protocol (IP) may be an appropriate communication medium, whereas cell or pager messages may be the appropriate mechanism for other devices 111. Examples of other communication protocols that can be used include GPRS, SMS Edge, Java, SQL and the like. In one embodiment, the present invention is implemented using mobile device middleware available from Intellimatics of Coppell, Tex. Standard ODBC protocols can be used to communicate with Intellimatics databases (via standard SQL commands, a SQL Server database, and UDP, SMS, and/or TCP/IP messaging protocols).

Middleware 106 sends messages 107A to remotely located onboard device 111 installed in vehicle 109. In one embodiment, modem 120 in device 111 receives such messages 107A. Messages 107A instruct onboard device 111 to perform various operations, such as disabling vehicle starter circuitry 112 in order to prevent operation of vehicle 109, outputting alerts or other information to owner 110 via wireless device 152, or the like. Messages 107A may also inform device 111 with respect to a number of emergency overrides available to the vehicle owner or other driver such that the driver can temporarily enable an otherwise disabled vehicle, as described further below. The number of available emergency overrides in a given payment period may be selected by system administrator 104 or the lender. The number of available emergency overrides may be stored in memory 113. Further, the number of emergency overrides may be stored in database 118, and onboard device 111 may communicate an invocation of an emergency override back to operations center 101 so that the number of available emergency overrides may be decremented accordingly, also described below. Although described in terms of middleware 106, in at least some alternative embodiments, middleware 106 may be omitted and software 102 may communicate directly with onboard device 111 and/or external agent 108, as appropriate.

If a vehicle owner fails to make a payment as scheduled, onboard device 111 may disable operation of the vehicle (or other device protected by a payment enforcement system) by, for example, interrupting the vehicle starter circuitry. Techniques for disabling and re-enabling a vehicle are described in the commonly-owned, U.S. Patent Application Publication No. 2012/0239223, titled “Methods and Systems of Selectively Enabling a Vehicle by Way of a Portable Wireless Device”, published Sep. 20, 2012, which is hereby incorporated by reference as if fully reproduced herein. However, should an emergency arise, a disabled vehicle may be an owner or operator's only ready means of transportation. Thus, system 10 includes mechanisms by which an operator of such a disabled motor vehicle may effect re-enablement of the vehicle to provide emergency operation of the vehicle. For example, onboard device 111 may be programmed with a number of available emergency overrides that are available to the operator over the length of a payment period. In at least some embodiments, the number of available emergency overrides may be selected by the lender. Alternatively, or in addition to the lender, the system administrator may select the number of emergency overrides. The number of emergency overrides may be communicated to onboard device 111 by any of the communication mechanisms described above, for example via messages 107A. However selected, onboard device 111 is thus aware of the number of emergency overrides available to the operator of the vehicle in any given payment period, and may track the usage thereof as described further below.

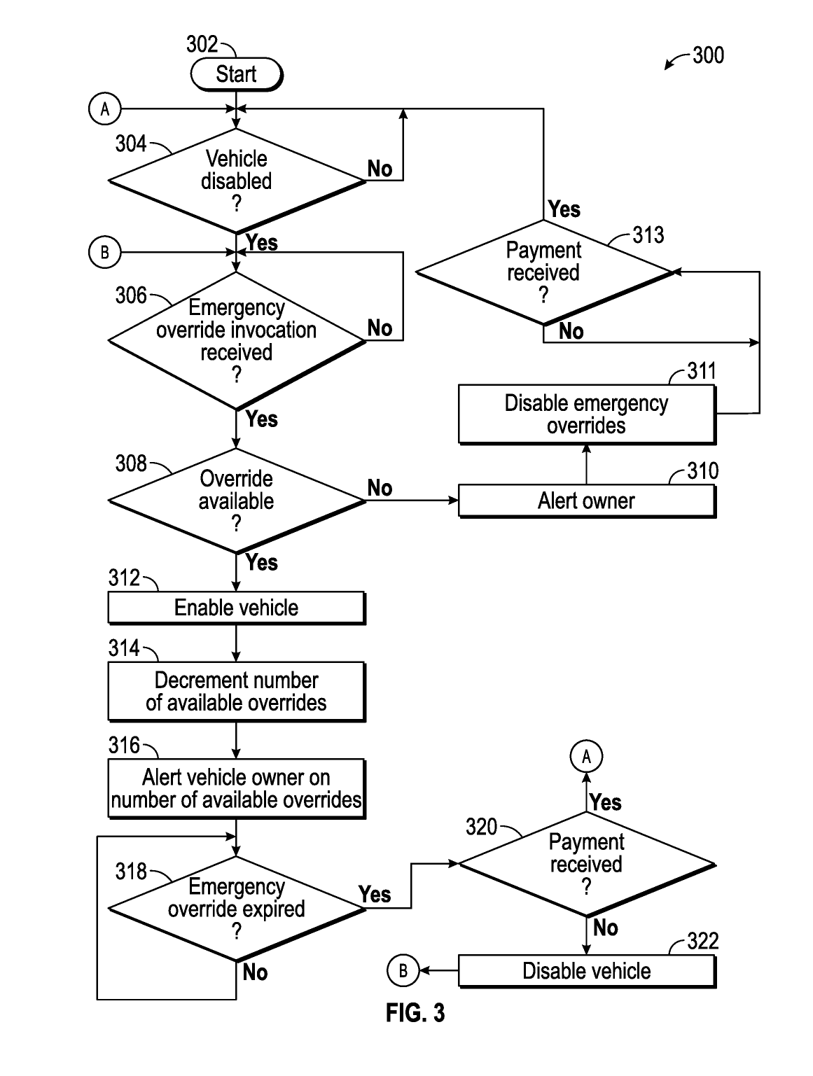

In at least some embodiments, an operator of a disabled vehicle may invoke an emergency override by entering a preselected access code on wireless device 152. Wireless device 152 may then transmit the code to onboard device 111 via wireless interface 151. For example, a code comprising six “9s”, i.e. “999999”, may be entered is sequence on a keypad or touch-sensitive screen of wireless device 152 which may then be transmitted to onboard device 111 as described above. On receipt of the preselected code, onboard device 111 may then enable the vehicle as described further in conjunction with FIG. 3. Alternatively, or in addition to wireless device 152, vehicle owner 110 may be provided with an infrared (IR) remote device 155 equipped with a keypad or touch-sensitive screen on which the operator can enter the code to invoke an emergency override. The code may then be communicated in IR message 159 to onboard device 111 via IR sensor and interface 157 coupled to processor 1105 which may then detect the requested invocation and enable the vehicle as described below. In at least some embodiments, IR remote device 155 may use a Holtek HT6221/HT6222 or compatible encoder, available from Holtek Semiconductor, Inc., of Taiwan. IR sensor and interface 157 may be implemented, in at least some embodiments, using a receiver such as the TSOP1238 IR Receiver, available from Vishay Intertechnology, Inc. of Malvern, Pa.

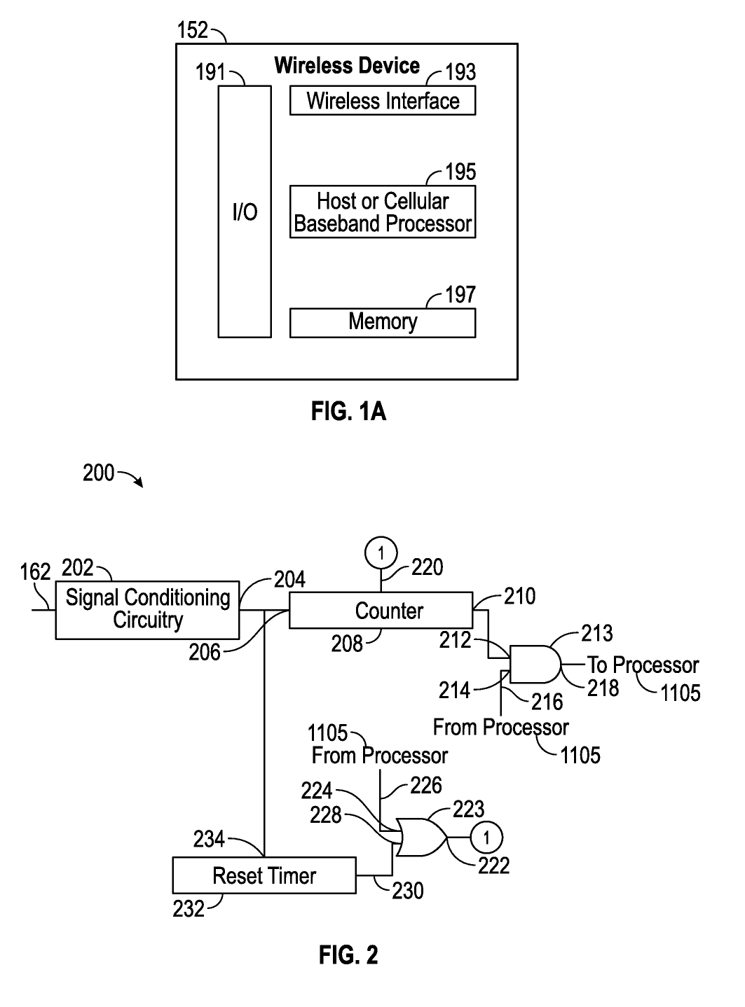

System 10 may also include mechanisms to invoke an emergency override that do not rely on an external device, such as wireless device 152 or IR remote device 155. In such embodiments, a disabled vehicle may be enabled in an emergency if the external device is lost, forgotten or fails. An exemplary embodiment of such a system 10 includes override sense logic 161 coupled to processor 1105 and to one or more user-actuated vehicle components. For example, override sense logic 161 may be connected to a neutral line of vehicle ignition switch/start button 163 via a sense wire 162. When ignition switch/start button 163 is actuated by the operator of vehicle 109, sense wire 162 is connected to the electrical power of vehicle 109, typically a 12V battery. Override sense logic 161 may then detect the application of the power to sense wire 162, and use that signal to initiate enablement of the disabled vehicle via processor 1105. For example, override sense logic 161 may detect a preselected “on-off” sequence of ignition switch/start button 163 to initiate enablement of vehicle 109. Thus, the operator of the vehicle may perform the particular on-off sequence to invoke an emergency override of the disabled vehicle. An example of this mechanism will be described in further detail below in conjunction with FIGS. 2 and 3.

Similarly, override sense logic 161 may be coupled to other user-activated vehicle components. For example, override sense logic 161 may connect to the neutral line of the high-beam headlight switch 165 via sense wire 166, and may detect a particular number of “flashes” of the high beam headlights when they are energized by the switch connection to the vehicle power. Likewise, activation by the operator of interior light switch 167 may be sensed by override sense logic 161 via sense wire 169. Another such operator-activated input may be sensed at horn switch 171 via sense wire 173 coupled to the neutral line of the horn switch. The operator may then invoke an emergency override by blowing the vehicle horn a particular number of times.

In at least some other embodiments, vehicle 109 may be equipped with switches mechanically coupled to one or more of the hand brake, brake pedal and clutch pedal. In such exemplary embodiments, operating the respective device may, through the respective switch effect a switch closure to vehicle electrical ground, say, which may then be detected by override sense logic 161. Thus, hand brake switch 175 may be coupled to override sense logic 161 via sense wire 177, to clutch pedal switch 174 via sense wire 178 and to brake pedal switch 179 via sense wire 181. In the case of a switch closure to vehicle electrical ground, override sense logic 161 may provide a bias voltage on sense wires 177, 178 and 181, not necessarily the 12V vehicle battery voltage, and then detect the “high-to-low” transition on the sense wires on operation of the respective vehicle device. However, with respect to the brake pedal, the sense wire may, alternatively, be coupled to the neutral line of the brake lights, and detect the powering of the brake lights when the brake pedal is operated. In each of these embodiments, the invocation of the emergency override may be effected by the operator actuating the respective device a particular number of times. Thus, for example, the operator may press and release the clutch pedal a particular number of times which may then be detected by override sense logic 161, as will now be described.

FIG. 2 shows a block diagram of a portion 200 of override sense logic 161 in accordance with at least some embodiments. Connections to power buses and the like are not shown in FIG. 2 inasmuch as they do not implicate the principles embodied in the examples described herein and would be understood by persons skilled in the art having the benefit of the disclosure. Further, the devices and circuitry included in portion 200, although shown, for ease of illustration, in a single instance may be duplicated in override sense logic 161 to accommodate multiple sense wires as in the exemplary system 10. For concreteness, portion 200 will be described in terms of invoking an emergency override using ignition switch/start button 163 actuation, however the principles of operation are also substantially the same using any of the exemplary user-actuated vehicle components.

To detect a user invoking an emergency override of a disabled vehicle, via actuation of ignition switch 163 sense wire 162 may be coupled to signal conditioning circuitry 202. Signal conditioning circuitry may, for example, function to level shift the voltages on sense wire 162 from the 12V typically provided by the vehicle to voltages compatible with logic devices within override sense logic 161. Further, as ignition switch/start button 163 is switched from the off state to the on state, the voltage on sense wire 162 rises to the vehicle battery voltage, however, the mechanical switch contacts may be subject to a vibration or “bounce” which can be reflected in an oscillation on the leading edge of the signal on sense wire 162. Signal conditioning circuitry 202 may also comprise circuitry to “de-bounce” the signal such that the output signal from signal conditioning circuitry 202 monotonically increases in transitioning from the off to on state of ignition switch/start button 163.

As previously described, the vehicle operator may invoke an emergency override by actuating ignition switch/start button 163 a particular number of times. To detect the emergency override, the signal on sense wire 172, suitably conditioned at output port 204 of signal conditioning circuitry 202, may be coupled to a clock input 206 of a counter 208. For example, counter 208 may be an N-stage ring counter with N corresponding to the number of times the user actuates the ignition switch/start button (or other user-actuated component) to invoke an emergency override. The de-bouncing by signal conditioning circuitry 202 helps mitigate against inadvertent clocking of counter 208. Output port 210 of counter 208 is coupled to an input port 212 of AND gate 213. A second port, port 214 of AND gate 213 may be coupled to processor 1105 via enable line 216. Enable line 216 provides a mechanism for disabling emergency overrides, by negating enable line 216, as described further below in conjunction with FIG. 3. After N actuations, output port 210 of counter 208 is asserted, thereby asserting output 218 of AND gate 213, provided enable line 216 is asserted. Output 218 may be coupled to processor 1105 which may detect the emergency overrode invocation, also described below in conjunction with FIG. 3.

A vehicle owner may have a prescribed number of available emergency overrides in any one payment period. To mitigate against inadvertent invocation of an emergency override, the number of user ignition switch/start button actuations (or other user actuations) may need to occur within a defined time interval. Thus, in at least some embodiments, a counter reset line 220 may be asserted based on the expiry of a reset timer 232. Reset line 230 may be asserted by reset timer 232 on expiry of the defined time interval. Reset line 232 may be coupled to an input port 228 of an OR gate 223, output port 222 of which is coupled to reset line 220 of counter 208. A second input of OR gate 223, input port 224, may be coupled to processor 1105 via reset line 226 to provide a processor-initiated reset of counter 208. Reset timer 232 starts upon the assertion of timer start 234 coupled to the output port 204 of signal conditioning circuitry 202. Reset timer 232 may have a preselected fixed time interval, or may be, in at least some embodiments, a programmable time interval, or in still other embodiments, may be a software timer defined in the firmware executed by processor 1105.

In at least some alternative embodiments, the state of ignition switch/start button 163 may be determined by monitoring the CAN bus rather than by a sense wire coupled to the switch. By detecting the OBD codes reflecting the state of ignition switch/start button 163, the on-off sequences corresponding to the user actuations invoking an emergency override, a clock signal may be generated and coupled to clock input 206 of counter 208.

To further appreciate the emergency override techniques of the exemplary embodiments, turn now to FIG. 3 showing a flow chart of a method 300 in accordance with at least some embodiments. Method 300 may be performed in whole or in part by processor 1105 executing software implementing the actions of method 300, and may be performed serially or in parallel with other operations performed by processor 1105. Method 300 starts at block 302 and, if the vehicle is not disabled, loops at block 304, via the “No” branch. If the vehicle is disabled, method 300 breaks out of the loop via the “Yes” branch of block 304 to block 306. At block 306, method 300 loops, breaking out of the loop, via the “Yes” branch, if an emergency override invocation is received, for example, by detecting the assertion of output 218 of AND gate 213 in the exemplary embodiment of FIG. 2. On breaking out of the loop, method 300 proceeds by the “Yes” branch of block 306 to block 308.

In block 308, it is determined if an emergency override is available. Recall, the vehicle owner may be provided with a preselected number of emergency overrides in any payment period. If the vehicle owner has exhausted the available emergency overrides, method 300 exits block 308 via the “No” branch and the owner is alerted, at block 310. The vehicle owner may be alerted using an audio tone from the device or any one or more of the messaging techniques described above. Emergency overrides may be disabled, block 311, by, for example, negating enable line 216, FIG. 2. At block 313, method 300 loops, via the “No” branch, pending the required payment being received. Receipt by the lender of the required payment may be communicated to onboard device 111 using any of the messaging techniques described above. By way of example, technology trigger 121 can inform software 102 that a payment has been received as described above in conjunction with FIG. 1. Event logic 115 can tell software 102 to invoke middleware 106 to send a message 107A to onboard device 111 accordingly. Further onboard device 111 may query operations center 101, via a message 107A for example, to ascertain the status of the required payment. On ascertaining receipt of the payment, method 300 breaks out of the loop via the “Yes” branch and returns to block 304. Otherwise, if an emergency override is available, method 300 proceeds via the “Yes” branch of block 308 and the vehicle is enabled at block 312. The vehicle may be enabled for a preselected period of time, as described further below at block 318. In block 314, the number of available overrides is decremented by one, and the vehicle owner alerted as to the number of emergency overrides remaining, at block 316. Again, the vehicle owner may be alerted by any one or more of the messaging techniques previously described.

An emergency override may enable the vehicle for a preselected period of time. For example, after invoking an emergency override, the vehicle may be enabled for twenty-four hours, or other preselected period of time which may be in a range from one to seventy-two hours, say. At block 318, method 300 loops, and upon expiry of the emergency override period, exits block 318 via the “Yes” branch. If, during the emergency override period, the lender has received a required payment, method 300 returns, via the “Yes” branch of block 320, to block 304 where it loops unless the vehicle is again disabled. Receipt by the lender of the required payment may be communicated to onboard device 111 as described above in conjunction with block 313. Otherwise, method 300 disables the vehicle, at block 322, and method 300 returns to block 306 where it loops unless another emergency override is invoked.

The above discussion is meant to be illustrative of the principles and various embodiments of the present invention. Numerous variations and modifications will become apparent to those skilled in the art once the above disclosure is fully appreciated. For example, a computer system installed in the vehicle by the manufacturer may be used to perform some or all of the processor-mediated tasks described herein. By way of another example, actuations of two or more vehicle components may be used in combination to invoke an emergency override by logically combining the conditioned sense signals from each. It is intended that the following claims be interpreted to embrace all such variations and modifications.

1.-7. (canceled)

8. A method comprising:
receiving an emergency override invocation from a user-actuated component of a device disabled by a payment enforcement system;
determining, based on a preselected number of emergency overrides, if an emergency override is available;
if an emergency override is available, enabling the device.

9. The method of claim 9 further comprising alerting an owner of the device if an emergency override is not available.

10. The method of claim 8 further comprising, if the device is enabled in response to the receiving the emergency override invocation, decrementing the number of available emergency overrides.

11. The method of claim 10 further comprising: alerting an owner of the device of a number of remaining available emergency overrides.

12. The method of claim 11 further comprising: determining if, during a period of enabling the device in response to invoking the emergency override, a payment is received by a lender.

13. The method of claim 11 wherein the alerting comprises: sending a message to a wireless device, the message comprising a remaining number of available emergency overrides.

14. The method of claim 8 wherein the device is enabled for a preselected period of time.

15. The method of claim 12 further comprising disabling the device if the payment is not received by the lender.

16. The method of claim 8 wherein the device comprises a vehicle and the user actuated device component is selected from the group consisting of:
an ignition switch;
a start button;
a brake pedal;
a clutch pedal;
a headlight switch;
a hand brake switch;
a horn switch; and
an interior light switch.

17. A system comprising:
a processor;
circuitry coupled to the processor and configured to disable and enable a vehicle on command from the processor;
circuitry coupled to the processor and a user-actuated vehicle component; and
a computer readable memory device coupled to the processor, the memory device storing a non-transitory set of instructions that, when executed by the processor, cause the processor to:
detect, via the circuitry coupled to the user-actuated vehicle component, an emergency override invocation received from a user-actuated vehicle component;
based on a preselected number of emergency overrides, determine if an emergency override is available;
if an emergency override is available, enable the vehicle via the circuitry configured to disable and enable the vehicle; and
decrement the number of available emergency overrides.

18. The system of claim 17 wherein the set of instructions that, when executed by the processor, further cause the processor to: communicate the number of available emergency overrides to an operations center.

19. The system of claim 17 wherein the set of instructions that, when executed by the processor, further cause the processor to communicate the number of available emergency overrides to a vehicle owner.

20. The system of claim 19 wherein the number of available emergency overrides is communicated to the user via a wireless communication link.

21. The system of claim 20 wherein the wireless communication link is selected from the group consisting of:
a Bluetooth link;
a Near Field Communication (NFC) link;
a Wi-Fi link; and
a cellular telephone link.

22. The system of claim 17 wherein the user-actuated vehicle component is selected from the group consisting of:
an ignition switch;
a start button;
a brake pedal;
a clutch pedal;
a headlight switch;
a hand brake switch;
a horn switch; and
an interior light switch
